(19) United States
(12) Patent Application Publication
(10) Pub. No.: US 2007/0223373 A1
(43) Pub. Date: Sep. 27, 2007

(54) Communication control apparatus and communication control method

(75) Inventors: Masahiro Sato, Kawasaki (JP); Jun Tanaka, Kawasaki (JP); Kazuto Nishimura, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/475,932

(22) Filed: Jun. 28, 2006

(30) Foreign Application Priority Data
Mar. 24, 2006 (JP) 2006-083941

(51) Int. Cl. H04L 12/26; H04L 12/28

(52) U.S. Cl. 370/229; 370/403

(57) ABSTRACT

A determining unit determines an allowable rate of data input permitted at a local node. A generating unit generates, when the allowable rate determined by the determining unit is equal to or greater than a target rate of the local node, extended control information including satisfaction information indicating that the target rate is achieved. A transmitting unit transmits the extended control information generated by the generating unit to an upstream node.

### BACKGROUND OF THE INVENTION

1) Field of the Invention

The present invention relates to a technology for preventing a communication rate in a node from oscillating and distributing a bandwidth evenly to a plurality of nodes constituting a communication network.

2) Description of the Related Art

Recently, a resilient packet ring (RPR) has been receiving attention as a communication technology in the field of metropolitan area network (MAN). The RPR is configured with a plurality of nodes connected to one another in a double-ring form, which is standardized in compliance with the IEEE 802.17. When trouble develops between any two of the nodes, the RPR switches the communication route to the opposite direction within 50 milliseconds, exhibiting a SONET/SDH-level trouble recovery capacity. The RPR is also characterized by its evenly distributed bandwidths.

More specifically, there are two types of traffic at a node in the RPR; the traffic of data coming from an upstream node and passing this node, and the traffic of data being input at this node. Of the two types of traffic, the traffic of data passing the node is given precedence to the other. The input traffic is therefore blocked at a downstream node when heavy traffic comes down from the upstream nodes. For this reason, the RPR evenly distributes bandwidths to all the nodes to prevent the input rates from being unbalanced among upstream and downstream nodes.

To increase the input rate of the downstream nodes, it is necessary to lower the input rates of the upstream nodes. Thus, when a downstream node detects congestion at itself, the node puts back-pressure on the upstream nodes to control their input rates. As a result, the input rate of the downstream node increases in accordance with the lowered input rates of the upstream nodes, restoring balance to the input rates of the nodes. More specifically, the downstream node, when detecting congestion, informs the upstream nodes of its own input rate as a control rate. Upon receiving the control rate, the upstream nodes make adjustments to bring their input rates down to the control rate. This lowers the input rates of the upstream nodes, while the input rate of the downstream node gradually increases, which increase the control rate. The upstream nodes and the downstream node that has detected the congestion are eventually allowed to have the input traffic at the same input rate.

Such a control for ensuring evenness of bandwidths is performed also with the SONET/SDH, as disclosed in Japanese Patent Application Laid-Open No. 2004-525538.

However, when the above control is performed at the time of congestion, the input traffic is not stabilized at the nodes owing to the congestions being relieved and recurring, which results in a problem that evenness among the nodes cannot be ensured. A specific example will be given below to explain this problem.

FIG. 7A is a diagram of an example of a communication network including nodes 1 to 7 to which the RPR is applied. A ring capacity rate, which indicates the maximum transmission rate for the entire ring over the communication network, is set to 100 megabits per second (Mbps). In this communication network, when the node 1 and the node 2 perform transmission to the node 4 at the input rate of 40 Mbps, the downstream node 3 has a target rate of 30 Mbps for the transmission to the node 4, but the actual input rate of the node 3 becomes 20 Mbps because the passing traffic from the upstream nodes is given precedence.

Then, the traffic rate from the nodes 1 to 3 to the node 4 reaches the ring capacity rate, causing congestion between the node 3 and the node 4. The node 3 detects the congestion and informs the node 2 and the node 1 of its own input rate of 20 Mbps as a control rate. At the node 1 and the node 2 that are informed of the control rate control to bring their input rates down to the control rate of 20 Mbps. For instance, the input rates of the node 1 and the node 2 are reduced to 35 Mbps, as illustrated in FIG. 7B. Because the reduction of the input rates of the node 1 and the node 2 is 10 Mbps in total, this amount is added to the input rate of the node 3, increasing the input rate of the node 3 to 30 Mbps.

As a result, the node 3 achieves the targeted input rate. However, the traffic rates from the nodes 1 to 3 to the node 4 are still at the ring capacity rate, and thus the congestion would not be relieved between the node 3 and the node 4. The node 3 continues to inform the node 2 and the node 1 of its own input rate, which is 30 Mbps, as a control rate. The input rates of the node 1 and the node 2 eventually become the same as the input rate of the node 3, 30 Mbps, as indicated in FIG. 7C, which means that the input rates of the nodes 1 to 3 are 90 Mbps in total. This is under the ring capacity rate, and thus the congestion is relieved.

Yet, after the congestion is relieved, the node 2 and the node 1 are no longer informed of the input rate of the node 3 as a control rate. Without being informed of a control rate, the node 1 and the node 2 increase their input rates back to the targeted 40 Mbps. The passing traffic from the upstream nodes that has priority lowers the input rate of the node 3 to 20 Mbps, which causes congestion between the node 3 and the node 4 again, back to the situation as shown in FIG. 7A. From this on, the situations of FIG. 7A through FIG. 7C repeat, making the input rates of the nodes 1 to 3 unstable and oscillate. In addition, because the input rate of the node 3 is always the same as or under the input rates of the nodes 1 and 2, bandwidths are not evenly distributed.

### SUMMARY OF THE INVENTION

It is an object of the present invention to at least partially solve the problems in the conventional technology.

A communication control apparatus according to one aspect of the present invention, in a node that transmits control information including a control rate for controlling an input rate of an upstream node when a congestion occurs during a data transmission from the upstream node to a downstream node in a communication network including a plurality of nodes connected in a form of a ring, includes a determining unit that determines an allowable rate of data input permitted at a local node; a generating unit that generates, when the allowable rate determined by the determining unit is equal to or greater than a target rate of the local node, extended control information including satisfaction information indicating that the target rate is achieved; and a transmitting unit that transmits the extended control information generated by the generating unit to the upstream node.

A communication control method according to another aspect of the present invention, which is for a communication control apparatus in a node that transmits control information including a control rate for controlling an input rate of an upstream node when a congestion occurs during a data transmission from the upstream node to a downstream node in a communication network including a plurality of nodes connected in a form of a ring, includes determining an allowable rate of data input permitted at a local node; generating, when the allowable rate determined at the determining is equal to or greater than a target rate of the local node, extended control information including satisfaction information indicating that the target rate is achieved; and transmitting the extended control information generated at the generating to the upstream node.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram for explaining the essential constitution of a node according to a first embodiment of the present invention;

FIG. 2A is a diagram of an example of an ordinary packet according to the first embodiment;

FIG. 2B is a diagram of an example of an extended packet according to the first embodiment;

FIG. 3 is a diagram of an example of transmission and reception of the extended packet according to the first embodiment;

FIG. 4A is a flowchart explaining the transmission operation of a control frame according to the first embodiment;

FIG. 4B is a diagram continued from FIG. 4A;

FIG. 5A is a diagram of an example of communications between nodes according to the first embodiment;

FIG. 5B is a diagram continued from FIG. 5A;

FIG. 5C is a diagram continued from FIG. 5B;

FIG. 5D is a diagram continued from FIG. 5C;

FIG. 6A is a diagram of an example of communications between nodes according to a second embodiment of the present invention;

FIG. 6B is a diagram continued from FIG. 6A;

FIG. 6C is a diagram continued from FIG. 6B;

FIG. 7A is a diagram of an example of communications between nodes when congestion arises;

FIG. 7B is a diagram continued from FIG. 7A; and

FIG. 7C is a diagram continued from FIG. 7B.

### DETAILED DESCRIPTION OF THE PREFERRED EMBODIMENTS

Exemplary embodiments of the present invention will be explained in detail below with reference to the accompanying drawings. Although an example of a communication network to which the RPR is applied will be explained, the present invention is applicable to any communication network in which a plurality of nodes are connected in the form of a ring in such a manner that the transmission path would not diverge and downstream nodes can control the input rates of the upstream nodes as needed. In the following description, the nodes are connected in the shape of a ring to transmit data in the clockwise direction. Nodes positioned downstream in the data transmission path with respect to a specific node are referred to as downstream nodes, while nodes positioned upstream in the data transmission path are referred to as upstream nodes.

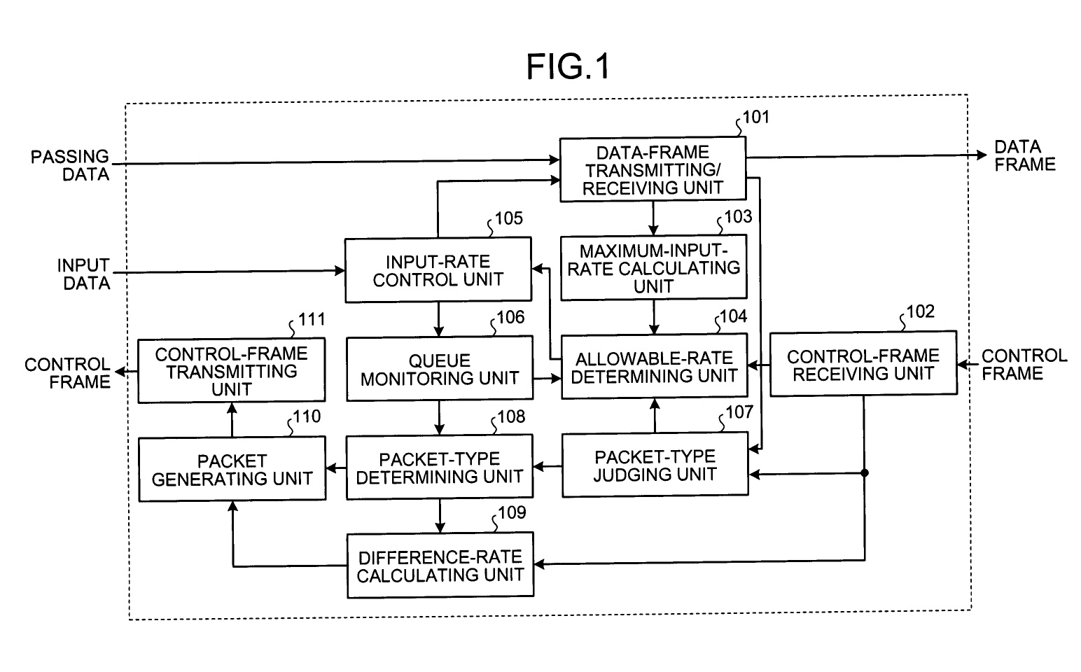

FIG. 1 is a block diagram for explaining the essential constitution of a node according to a first embodiment of the present invention. The node is included in a communication network to which the RPR is applied. The node shown in FIG. 1 includes a data-frame transmitting/receiving unit 101, a control-frame receiving unit 102, a maximum-input-rate calculating unit 103, an allowable-rate determining unit 104, an input-rate control unit 105, a queue monitoring unit 106, a packet-type judging unit 107, a packet-type determining unit 108, a difference-rate calculating unit 109, a packet generating unit 110, and a control-frame transmitting unit 111.

The data-frame transmitting/receiving unit 101 receives a data frame including passage data that is to be transmitted from an upstream node (not shown), via the node of interest, down to a downstream node (not shown). The data-frame transmitting/receiving unit 101 also transmits data frames including the passage data and input data that is input from the node of interest, to the downstream node. The data frame received by the data-frame transmitting/receiving unit 101 may include data addressed to the node of interest, although it is omitted from FIG. 1.

The control-frame receiving unit 102 receives control frames from downstream nodes, at intervals of predetermined time. According to the present embodiment, the control-frame receiving unit 102 receives two types of packets as control frames. The control-frame receiving unit 102 receives either an ordinary packet including ordinary control data or an extended packet including a control rate that indicates the upper limit of the input rate of the node of interest and satisfaction information that indicates the input rates of the downstream nodes having reached the target rates. It should be noted that the ordinary packet may or may not include a control rate as control data.

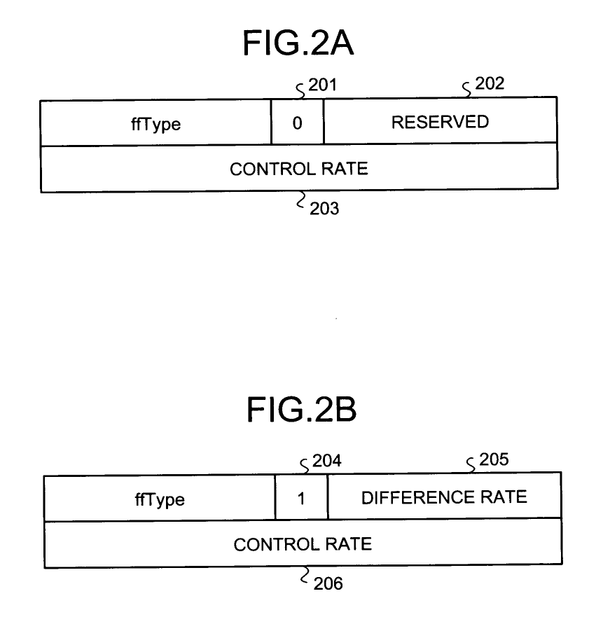

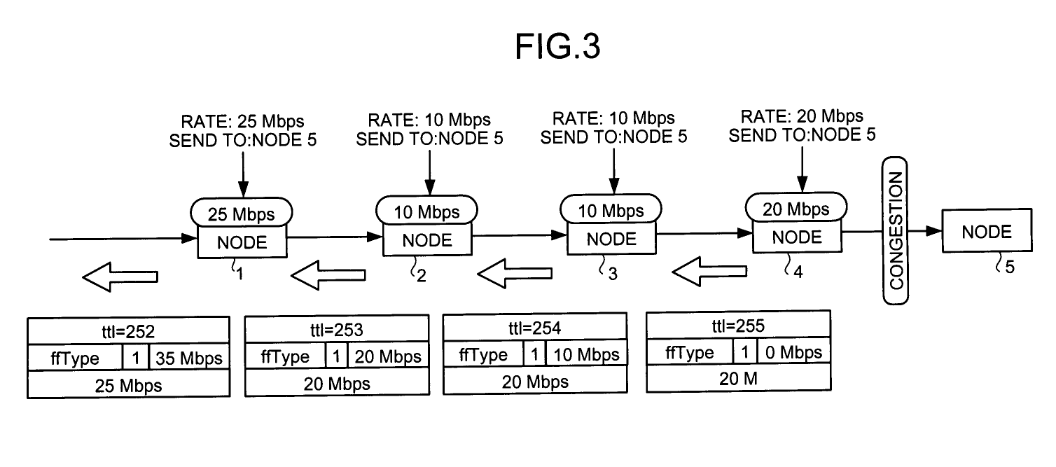

The data portion of the ordinary packet has a format as shown in FIG. 2A, for example, where the bit of a satisfaction information field 201 is zero. For the satisfaction information field 201, the most significant bit of a reservation field 202 is used. If an ordinary packet with the bit of the satisfaction information field 201 being zero is received, it means that the input rate of a downstream node has not reached the target rate. The reservation field 202 contributes to the scalability of a packet, and does not contain any information in an ordinary packet. Further, a control rate field 203 includes information of a control rate that is equal to the maximum input rate among the downstream nodes located between the node of interest and the congestion point.

On the other hand, the data of an extended packet has a format as illustrated in FIG. 2B, for instance, where the bit of a satisfaction information field 204 is 1. Reception of the extended packet with the bit of the satisfaction information field 204 being unity indicates that the input rates of all the downstream nodes have reached the target rates. Further, a reservation field 205 of the extended packet stores difference rate information. A difference rate refers to a rate obtained by accumulating differences between the control rate and the input rate of each of the downstream nodes, and indicates how low the actual input rate of each downstream node is with respect to the control rate included in the extended packet. This difference rate is used to calculate the sum of the input rates of all the downstream nodes. A control rate field 206 includes information on the control rate that is equal to the maximum input rate among the downstream nodes located between the node of interest and the congestion point.

The maximum-input-rate calculating unit 103 calculates the maximum input rate that indicates the input capacity at the node of interest by subtracting the traffic rate of the passage data flowing from the upstream nodes to a downstream node, from the ring capacity rate that indicates the maximum transmission traffic rate of the entire ring.

The allowable-rate determining unit 104 determines an allowable rate that shows the upper limit of the input rate of the node of interest by using a control rate in a control frame received by the control-frame receiving unit 102, a maximum input rate calculated by the maximum-input-rate calculating unit 103, an input rate informed of by the queue monitoring unit 106, and a difference rate in an extended packet. More specifically, when the control-frame receiving unit 102 receives an ordinary packet including a control rate, the allowable-rate determining unit 104 determines the received control rate as the allowable rate. When the control-frame receiving unit 102 receives an extended packet, the allowable-rate determining unit 104 determines, as the allowable rate, either a rate obtained by subtracting the sum of input rates of all the downstream nodes (hereinafter, “downstream rate”) from the maximum input rate or the received control rate, depending on the high/low relationship of the received control rate and the input rates. In addition, when the control-frame receiving unit 102 receives an ordinary packet without a control rate, the maximum input rate is determined as the allowable rate.

When calculating the downstream rate, the allowable-rate determining unit 104 uses a difference rate included in the extended packet. In other words, the allowable-rate determining unit 104 multiplies the number of downstream nodes by the received control rate and subtracts the difference rate from the multiplication result to obtain the downstream rate. The number of downstream nodes can be found from a numerical value of a time to live (ttl) field stored in the header of the extended packet, for example. As described above, because the control rate in the received control frame is equal to the maximum input rate among the downstream nodes, the input rates of all the downstream nodes are equal to or lower than the received control rate. In addition, because a difference between the received control rate and the input rate of each downstream node is accumulated as difference rate information in the extended packet, the sum of the actual inputs of the entire downstream nodes is calculated by subtracting the difference rate from the received control rate multiplied by the number of downstream nodes. When an extended packet is received and the received control rate is under the input rate, the allowable-rate determining unit 104 obtains an allowable rate by subtracting the downstream rate from the maximum input rate. This is exactly the same as a rate obtained by subtracting the sum of the passing traffic rate and the input rates of the downstream nodes from the ring capacity rate.

Because the difference rate is used in calculation of a downstream rate as described above, the extended packet could store the downstream rate itself in its reservation field 205. However, by holding the information in the form of a difference in comparison with the control rate, the amount of information can be reduced, which allows the limited number of bits of the reservation field 205 to be put to effective use.

The input-rate control unit 105 outputs the input data input at the node of interest to the data-frame transmitting/receiving unit 101, at the allowable rate determined by the allowable-rate determining unit 104 at highest. The input rate control unit 105 includes a queue to store input data in and outputs the input data stored in the queue to the data-frame transmitting/receiving unit 101 at an input rate that is the allowable rate at highest. It should be noted that, when an ordinary packet is received and the input rate is to be lowered with the allowable rate serving as a received control rate, the input-rate control unit 105 does not sharply bring the input rate down to the allowable rate, but controls the input rate to gradually come down to the allowable rate.

The queue monitoring unit 106 monitors the queue provided in the input-rate control unit 105. If any input data is stored in the queue, the queue monitoring unit 106 determines that the allowable rate is lower than the target rate of the node of interest, while if there is no input data in the queue, the queue monitoring unit 106 determines that the allowable rate is equal to or higher than the target rate of the node of interest. In other words, the queue monitoring unit 106 determines the high/low relationship of the allowable rate and the target rate of the node of interest by monitoring the queue. If no conjugation arises at a downstream node, or in other words, if the control-frame receiving unit 102 receives an ordinary packet that does not include a control rate, and if the allowable rate of the node of interest is lower than the target rate, conjugation arises at the node of interest itself. In addition, the queue monitoring unit 106 informs the allowable-rate determining unit 104 of the actual input rate based on the result of monitoring the queue.

The packet-type judging unit 107 determines whether a control frame received by the control-frame receiving unit 102 includes a control rate. Further, when the received control frame includes a control rate, the packet-type judging unit 107 determines whether this control frame is an ordinary packet or an extended packet, by referring to the satisfaction information field of the control frame. The packet-type judging unit 107 informs the allowable-rate determining unit 104 and the packet-type determining unit 108 of the packet type judgment result. When the received control frame includes a control rate, the packet-type judging unit 107 compares the received control rate with the passing traffic rate at the data-frame transmitting/receiving unit 101, and informs the packet-type determining unit 108 if the received control rate is equal to or more than the passing traffic rate.

The packet-type determining unit 108 determines a packet type of control frame that is to be transmitted from the node of interest to the upstream nodes in accordance with the determination result made by the queue monitoring unit 106 and the judgment result made by the packet-type judging unit 107. In particular, when the received control frame does not include a control rate, the packet-type determining unit 108 determines a packet type based on the determination result by the queue monitoring unit 106. In other words, the packet-type determining unit 108 determines that the packet type is an ordinary packet including a control rate if the allowable rate is under the target rate, that it is an extended packet if the allowable rate is equal to the target rate, and that it is an ordinary packet without a control rate if the allowable rate is higher than the target rate.

On the other hand, when the control frame is received and the packet-type judging unit 107 outputs the determination result indicating that an ordinary packet including a control rate has been received, the packet-type determining unit 108 determines that the packet type is an ordinary packet, regardless of the determination result by the queue monitoring unit 106. Furthermore, when the packet-type judging unit 107 outputs a judgment result indicating that an extended packet has been received, the packet-type determining unit 108 determines that the packet type is an ordinary packet including a control rate when the allowable rate is under the target rate, and that the packet type is an extended packet when the allowable rate is equal to or higher than the target rate. Furthermore, when the packet-type judging unit 107 informs the packet-type determining unit 108 that the received control rate is equal to or higher than the passing traffic rate, the input rates of the upstream nodes do not need to be controlled. Thus, the packet-type determining unit 108 determines that the packet type is an ordinary packet without a control rate.

In addition to the determination of a packet type for transmission, the packet-type determining unit 108 determines the control rate that is to be stored in the packet. In particular, when a control rate is not included in the received control frame and the packet type is determined to be an ordinary packet with a control rate or an extended packet, the packet-type determining unit 108 determines that the control rate is the input rate at the node of interest.

On the other hand, when the packet-type judging unit 107 outputs a judgment result indicating that an ordinary packet with a control rate has been received, the packet-type determining unit 108 determines that the control rate is the received control rate itself. Further, when the packet-type judging unit 107 outputs a judgment result indicating that an extended packet has been received, the packet-type determining unit 108 determines that the control rate is the input rate at the node of interest when the allowable rate is under the target rate, and determines that the control rate is either the input rate at the node of interest or the received control rate, whichever is higher, when the allowable rate is equal to or higher than the target rate.

The difference-rate calculating unit 109 calculates a difference rate from the received control rate received by the control-frame receiving unit 102 and the input rate of the node of interest when the packet-type determining unit 108 determines that the packet type is an extended packet. In particular, when an extended packet as illustrated in FIG. 2B is received and the allowable rate is equal to or higher than the target rate, the difference-rate calculating unit 109 subtracts the input rate of the input-rate control unit 105 from the received control rate of the control rate field 206, and adds the subtraction result to the difference rate of the reservation field 205 to obtain a new difference rate. At this point, if the packet-type determining unit 108 determines that the control rate is the input rate of the node of interest, the control rate that functions as a reference may be changed. Thus, the difference-rate calculating unit 109 re-calculates a difference rate for the downstream nodes.

An explanation will be given by citing a concrete example in which the nodes 1 to 4 transmit data to the node 5 at input rates of 25 Mbps, 10 Mbps, 10 Mbps and 20 Mbps, respectively, in this order from upstream. When congestion occurs at the node 4 and the target rate of each of the nodes 1 to 4 is equal to the input rate, the nodes 1 to 4 transmit an extended packet to upstream nodes. In other words, the node 4 transmits an extended packet to the node 3 with the control rate being the input rate 20 Mbps of the node 4. Because the control rate received from the node 4 is higher than the input rate of the node 3, the node 3 transmits an extended packet to the node 2 with the control rate being the received control rate 20 Mbps of the node 4. Because the control rate received from the node 3 is higher than the input rate of the node 2, the node 2 transmits an extended packet to the node 1 with the control rate being the received control rate 20 Mbps of the node 3.

Further, the node 1 transmits an extended packet to an upstream node that is not shown with the control rate being the input rate 25 Mbps of the node 1 because the input rate of the node 1 is higher than the received control rate of the node 2. In other words, because the control rate is changed at the node 1, it is necessary to calculate a difference rate with the control rate of 25 Mbps as a reference at the node 1, in contrast to the difference rate calculated with the control rate of 20 Mbps as a reference up to the node 2. Thus, the node 1 finds that the number of downstream nodes is 3 (nodes 2 to 4) by referring to a value in the ttl field and obtains the downstream rate of 40 Mbps (=received control rate 20 Mbpsx3−difference rate 20 Mbps). In addition, the node 1 obtains a new difference rate of 35 Mbps by subtracting the downstream rate of 40 Mbps from the control rate of 25 Mbps determined at the node 1 that is multiplied by the number of downstream nodes. This accurately brings the received control rate into correspondence with the difference rate when calculating the downstream rate at an upstream node that is not shown so that the downstream rate can be accurately calculated.

The packet generating unit 110 generates a packet of a packet type determined by the packet-type determining unit 108. In other words, the packet generating unit 110 generates an ordinary packet with the bit of the satisfaction information field being unity when the packet type is determined to be an ordinary packet. When the packet type is determined to be an extended packet, the packet generating unit 110 generates an extended packet with the bit of the satisfaction information field being 1. At this point, the packet generating unit 110 generates a packet in accordance with the presence/absence of a control rate determined by the packet-type determining unit 108. When generating an extended packet, the packet is generated to include a difference rate that is calculated by the difference-rate calculating unit 109. When an ordinary packet without a control rate is to be generated, the packet generating unit 110 sets all the bits in the control rate field 203 of the ordinary packet to 1, for instance.

The control-frame transmitting unit 111 transmits the ordinary packet or the extended packet generated by the packet generating unit 110 to an upstream node that is not shown, as a control frame.

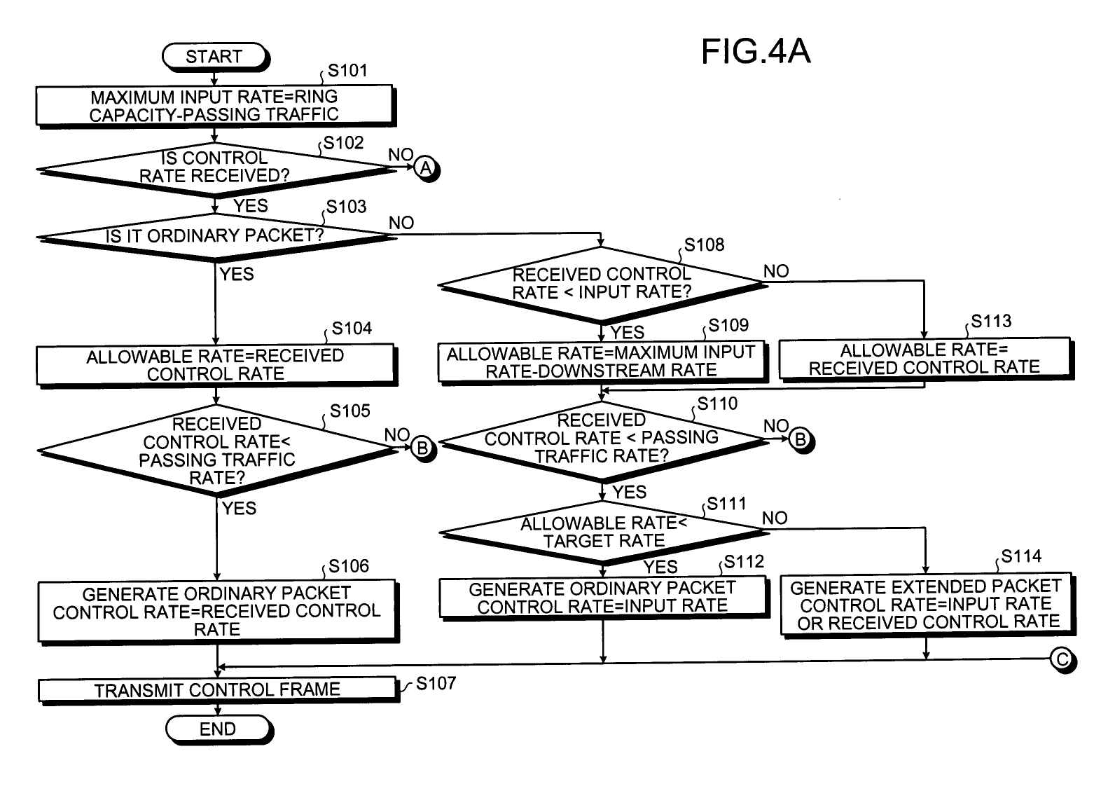

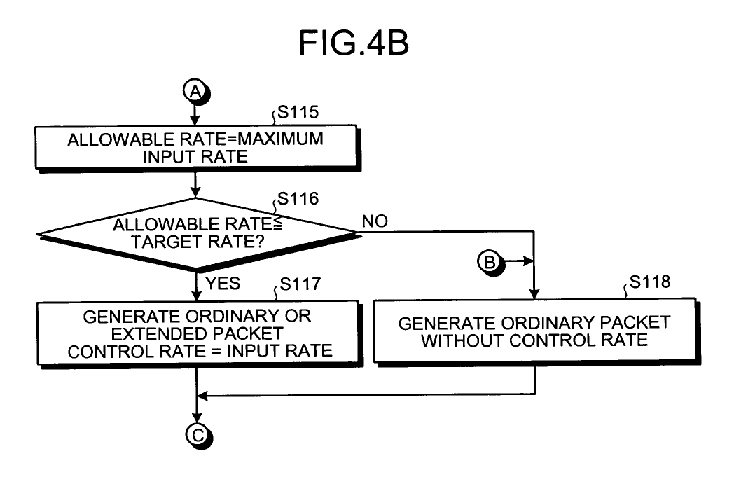

The control frame transmission operation of the node that is configured as above will be explained with reference to a flowchart shown in FIG. 4.

In the course of the passing traffic passing from the upstream nodes through the data-frame transmitting/receiving unit 101, the maximum-input-rate calculating unit 103 calculates a maximum input rate. In other words, the maximum-input-rate calculating unit 103 subtracts the passing traffic rate from the ring capacity rate to obtain the maximum input rate at the node of interest (Step S101). The obtained maximum input rate is output to the allowable-rate determining unit 104. Moreover, the control-frame receiving unit 102 receives a control frame from a downstream node, and the packet-type judging unit 107 checks whether the received control frame includes a control rate (Step S102).

A case in which an ordinary packet including a control rate is received will be explained first. When the packet-type judging unit 107 judges that the received control frame includes a control rate (Step S102, Yes), the packet-type judging unit 107 further refers to the satisfaction information field of the control frame to judge whether the packet type is an ordinary packet (Step S103). The judgment result on the packet type is sent to the allowable-rate determining unit 104. If the received packet type is an ordinary packet including a control rate (Step S103, Yes), the allowable-rate determining unit 104 determines that the allowable rate of the node of interest is the received control rate (Step S104).

Then, the packet-type judging unit 107 compares the received control rate with the passing traffic rate at the data-frame transmitting/receiving unit 101 (Step S105), and sends the result to the packet-type determining unit 108 only when the received control rate is equal to or higher than the passing traffic rate. When the received control rate is equal to or higher than the passing traffic rate (Step S105, No), the input rates do not need to be controlled at the upstream nodes because the passing traffic is small enough. Thus, the input rate should be controlled only at the node of interest. To inform the upstream nodes that there is no conjunction to be considered, an ordinary packet without a control rate is transmitted thereto, as described below (Step S118).

Furthermore, regardless of the relationship as to which of the received control rate and the passing traffic rate is higher, the received control frame that is an ordinary packet including a control rate shows that the target rate has not been reached at a downstream node. The input-rate control unit 105 therefore controls the input rate of the node of interest to come down to the input rate (i.e. allowable rate) of the downstream node that has not reached the target rate. If the input rate of the node of interest is primarily under the allowable rate, the input-rate control unit 105 controls the input rate using the allowable rate as the upper limit.

The packet-type determining unit 108 determines a packet type of a control frame that is to be transmitted to upstream nodes. If the received control rate is under the passing traffic rate (Step S105, Yes), the condition of the downstream node that has not reached the target rate needs to be passed on, as it is, to the upstream nodes. The packet type is therefore determined by the packet-type determining unit 108 to be an ordinary packet including a control rate. The control rate stored in the ordinary packet is equal to the received control rate. On the other hand, if the received control rate is equal to or more than the passing traffic rate (Step S105, No), the packet type is determined by the packet-type determining unit 108 to be an ordinary packet without a control rate because there is no congestion to inform the upstream nodes of, as described above.

The packet type and the control rate determined by the packet-type determining unit 108 are transmitted to the packet generating unit 110, where an ordinary packet whose control rate is equal to the received control rate (Step S106) or an ordinary packet without a control rate (Step S118) is generated. Then, the ordinary packet is transmitted by the control-frame transmitting unit 111 to the upstream nodes (Step S107).

When the packet-type judging unit 107 judges that the received control frame includes a control rate (Step S102, Yes), the packet-type judging unit 107 further refers to the satisfaction information field in the control frame to judge whether the packet type is an ordinary packet (Step S103). The judgment result on the packet type is transmitted to the allowable-rate determining unit 104, where, if the received packet type is an extended packet (Step S103, No), the received control rate is compared with the input rate informed of by the queue monitoring unit 106 (Step S108).

If the result is the received control rate being under the input rate (Step S108, Yes), the allowable rate of the node of interest is determined as the rate obtained by subtracting, from the maximum input rate, the downstream rate found from the difference rate in the received extended packet (Step S109). In other words, when the received packet type is an extended packet and the input rate of the node of interest is too high, the allowable rate is obtained by subtracting the sum of the passing traffic rate and the input rates of the entire downstream nodes from the ring capacity rate. On the other hand, when the received control rate is equal to or higher than the input rate (Step S108, No), the allowable rate of the node of interest is determined as the received control rate (Step S113). In other words, when the received packet type is an extended packet and the input rate is sufficiently small at the node of interest, the allowable rate is equal to the input rate of one of the downstream nodes.

Then, when the packet-type judging unit 107 compares the received control rate with the passing traffic rate at the data-frame transmitting/receiving unit 101 (Step S110), and only if the received control rate is equal to or higher than the passing traffic rate, the result is transmitted to the packet-type determining unit 108. The received control rate equal to or higher than the passing traffic rate (Step S110, No) means that the passing traffic is sufficiently small so that the input rates do not need to be limited at the upstream nodes. Thus, the input rate should be controlled at the node of interest only. To inform the upstream nodes that there is no congestion to consider, the node of interest sends an ordinary packet without a control rate (Step S118), in a similar manner to the case of the received packet type being an ordinary packet including a control rate.

Regardless of the high/low relationship between the received control rate and the passing traffic rate, the input-rate control unit 105 controls the input rate of the node of interest by using the allowable rate. At this point, the queue monitoring unit 106 monitors the queue in the input-rate control unit 105 and judgment is made as to whether the allowable rate is under the target rate of the node of interest, based on whether there is any input data stored in the queue (Step S111).

In other words, if there is any input data stored in the queue, a desired size of input data has not been sent out as a data frame, which means that the allowable rate is under the target rate. On the other hand, if there is no input data stored in the queue, a desired size of input data has been sent out as a data frame, which means that the allowable rate is equal to the target rate.

As a result of monitoring the queue by the queue monitoring unit 106, if the allowable rate is under the target rate (Step S111, Yes), the node of interest has not reached the target rate, in contrast to all the downstream nodes having reached their target rates. Thus, the packet type determined by the packet-type determining unit 108 is an ordinary packet including a control rate. In addition, the control rate stored in the ordinary packet is equal to the input rate of the node of interest.

The packet type and the control rate determined by the packet-type determining unit 108 are transmitted to the packet generating unit 110, where an ordinary packet whose control rate is equal to the input rate of the node of interest is generated (Step S112). Then, the ordinary packet including the control rate is transmitted to the upstream nodes by the control-frame transmitting unit 111 (Step S107).

Furthermore, as a result of monitoring the queue by the queue monitoring unit 106, if the allowable rate is equal to or higher than the target rate (Step S111, No), all the downstream nodes and the node of interest have achieved the target rates. Thus, the packet type is determined by the packet-type determining unit 108 to be an extended packet. The control rate stored in the extended packet is equal to either the received control rate or the input rate of the node of interest, whichever is higher than the other.

In a similar manner to a case in which the packet type is determined to be an ordinary packet, the packet generating unit 110 generates an extended packet whose control rate is equal to either the input rate of the node of interest or the received control rate (Step S114), and the extended packet is transmitted to the upstream nodes by the control-frame transmitting unit 111 (Step S107).

Finally, a case in which a control frame without a control rate (ordinary packet) is received, i.e. a case in which there is no congestion to be considered, will be explained. When the control rate is not received (Step S102, No), the allowable-rate determining unit 104 is not informed of a received control rate. Thus, the allowable-rate determining unit 104 determines that the allowable rate of the node of interest is the maximum input rate (Step S115).

Then, the input-rate control unit 105 controls the input rate of the node of interest, using the allowable rate as the upper limit. At this point, the queue monitoring unit 106 monitors the queue in the input-rate control unit 105 to determine which of the allowable rate and the target rate of the node of interest is greater than the other, based on whether there is any input data in the queue (Step S116).

As a result of monitoring the queue by the queue monitoring unit 106, if the allowable rate is equal to or under the target rate (Step S116, Yes), the node of interest has not reached the target rate, or the allowable rate is equal to the target rate. This means that there is congestion at the node of interest. Thus, a control frame including a control rate is sent to the upstream nodes. If the target rate has not been reached, the packet-type determining unit 108 determines that the packet type is an ordinary packet. If the allowable rate is equal to the target rate, the packet type is determined to be an extended packet. The control rate stored in the ordinary packet or the extended packet is equal to the input rate of the node of interest.

The packet type and the control rate determined by the packet-type determining unit 108 are sent to the packet generating unit 110, where an ordinary packet or an extended packet whose control rate is equal to the input rate of the node of interest (Step S117). Then, the ordinary packet or the extended packet is sent by the control-frame transmitting unit 111 to the upstream nodes (Step S107).

As a result of monitoring the queue by the queue monitoring unit 106, if the allowable rate is greater than the target rate (Step S116, No), the ring capacity rate is far from being reached, even when the input rate is the target rate at the node of interest. Thus, there is no congestion at the node of interest. A control rate is therefore not sent to the upstream nodes, and the packet generating unit 110 generates an ordinary packet without a control rate (Step S118). The ordinary packet without a control rate is then sent to the upstream nodes by the control-frame transmitting unit 111 (Step S107).

According to the present embodiment, when the ring capacity rate has reached the maximum level and congestion arises, an extended packet is sent to the upstream nodes if the target rates are reached at the node of interest and all the downstream nodes. If the target rate is not reached at the node of interest or any of the downstream nodes, an ordinary packet is sent to the upstream nodes. This means that only the input rate of the lowermost node that has not reached the target rate is sent to the upstream nodes as a control rate to control the input rates of the upstream nodes. Hence, once the target rates are reached at all the nodes, the input rates of the upstream nodes are no longer controlled. This prevents the communication rates from oscillating at nodes and enables the bandwidths to be equally distributed to the nodes that constitute the communication network.

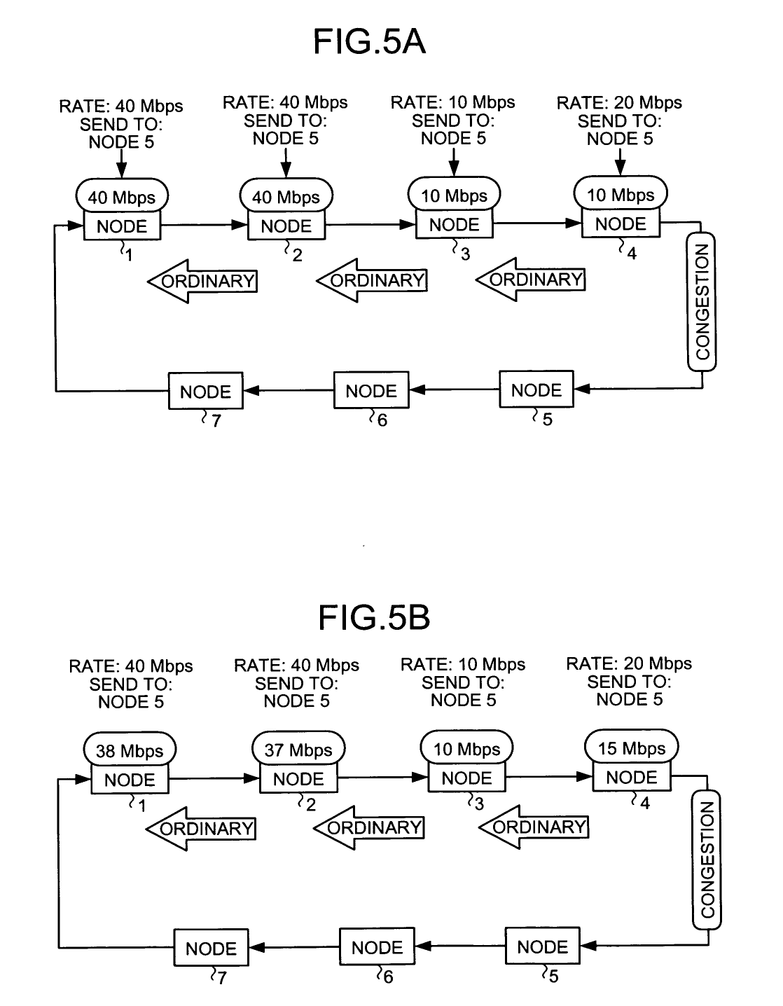

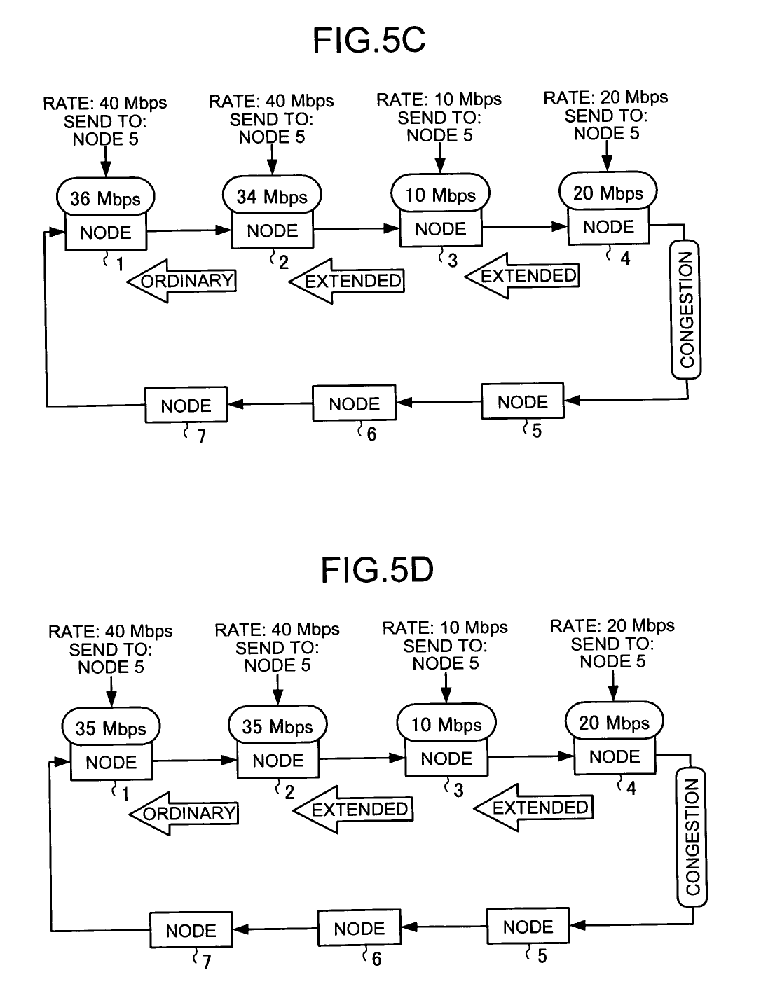

FIG. 5A is a diagram for explaining an RPR communication network including the nodes 1 to 7 in schematic form. The target rates of data transmission from the nodes 1 to 4 to the node 5 being 40 Mbps, 40 Mbps, 10 Mbps and 20 Mbps, respectively, will be considered. The ring capacity rate of the communication network illustrated in FIG. 5A is set to 100 Mbps.

Because upper nodes have precedence in the RPR, the input rate is initially set equal to the target rate at each of the nodes 1 to 3, and the passing traffic reaches 90 Mbps at the node 4. Because the ring capacity rate is 100 Mbps, the input rate of the node 4 has to be changed to 10 Mbps in place of the target rate of 20 Mbps. This causes congestion at the node 4, and the node 4 transmits an ordinary packet that includes a control rate being its own input rate of 10 Mbps, to the node 3.

The node 3 receives the transmitted ordinary packet, which brings the allowable rate of the node 3 to the received control rate of 10 Mbps and controls the input rate of the node 3. In other words, because the input rate of the node 3 is currently at 10 Mbps, the input rate is kept at 10 Mbps. In addition, because the ordinary packet is received, the node 3 sends an ordinary packet whose control rate is set to the received control rate of 10 Mbps, to the node 2.

The transmitted ordinary packet is received by the node 2, which brings the allowable rate of the node 2 to the received control rate of 10 Mbps and controls the input rate of the node 2. In other words, because the input rate of the node 2 is currently at 40 Mbps, the input rate is gradually reduced to the allowable rate of 10 Mbps. Moreover, because the ordinary packet is received, the node 2 transmits an ordinary packet whose control rate is set to the received control rate of 10 Mbps, to the node 1.

The transmitted ordinary packet is received by the node 1, which brings the allowable rate of the node 1 to the received control rate of 10 Mbps and controls the input rate of the node 1. In other words, because the input rate of the node 1 is currently at 40 Mbps, the input rate is gradually reduced to the allowable rate of 10 Mbps.

As a result of the input rates of the nodes 1 and 2 coming down to the allowable rate of 10 Mbps, the input rate of the downstream node 4 can be increased. More specifically, for instance as described in FIG. 5B, when the input rate of the node 1 is reduced to 38 Mbps and the input rate of the node 2 is reduced to 37 Mbps, the input rate of the node 4 increases by the total reduction amount of 5 Mbps, to 15 Mbps. However, because congestion still remains at the node 4 and the target rate of 20 Mbps has not yet been attained at the node 4, the node 4 sends an ordinary packet whose control rate is its own input rate of 15 Mbps, to the node 3.

The transmitted ordinary packet is received by the node 3, which brings the allowable rate of the node 3 to the received control rate of 15 Mbps and controls the input rate of the node 3. In other words, because the input rate of the node 3 is currently at 10 Mbps, the input rate is kept at 10 Mbps. In addition, because the ordinary packet is received, the node 3 sends an ordinary packet whose control rate is set to the received control rate of 15 Mbps, to the node 2.

The transmitted ordinary packet is received by the node 2, which brings the allowable rate of the node 2 to the received control rate of 15 Mbps and controls the input rate of the node 2. In other words, because the input rate of the node 2 is currently at 37 Mbps, the input rate is gradually reduced to the allowable rate of 15 Mbps. Moreover, because the ordinary packet is received, the node 2 transmits an ordinary packet whose control rate is set to the received control rate of 15 Mbps, to the node 1.

The transmitted ordinary packet is received by the node 1, which brings the allowable rate of the node 1 to the received control rate of 15 Mbps and controls the input rate of the node 1. In other words, because the input rate of the node 1 is currently at 38 Mbps, the input rate is gradually reduced to the allowable rate of 15 Mbps.

From then on, transmission of an ordinary packet to the upstream nodes and control of the input rates of the upstream nodes are repeated. For instance, as illustrated in FIG. 5C, when the input rate of the node 1 is reduced to 36 Mbps, and the input rate of the node 2 is reduced to 34 Mbps, the input rate of the node 4 becomes 20 Mbps. At this point, there is still congestion at the node 4, but because the allowable rate of the node 4 becomes equal to the target rate of 20 Mbps, the node 4 sends an extended packet whose control rate is its own input rate of 20 Mbps, to the node 3.

The transmitted extended packet is received by the node 3, and the input rate of the node 3 is controlled with the allowable rate of the node 3 becoming equal to the rate of 10 Mbps, which is obtained by subtracting the sum of the passing traffic rate and the input rates of all the downstream nodes (=36 Mbps+34 Mbps+20 Mbps) from the ring capacity rate of 100 Mbps. In other words, because the input rate of the node 3 is currently at 10 Mbps, the input rate is kept at 10 Mbps. Furthermore, because the extended packet is received and the allowable rate of the node 3 is equal to the target rate of 10 Mbps, the node 3 sends an extended packet whose control rate is the received control rate of 20 Mbps that is greater than the input rate of 10 Mbps, to the node 2.

The transmitted extended packet is received by the node 2, and the input rate of the node 2 is controlled with the allowable rate of the node 2 becoming equal to the rate of 34 Mbps, which is obtained by subtracting the sum of the passing traffic rate and the input rates of all the downstream nodes (=36 Mbps+10 Mbps+20 Mbps) from the ring capacity rate of 100 Mbps. In other words, the input rate of the node 2 is currently at 34 Mbps, the input rate is kept at 34 Mbps. Furthermore, because the extended packet is received and the allowable rate 34 Mbps of the node 2 is under the target rate of 40 Mbps, the node 2 sends an ordinary packet whose control rate is the input rate of 34 Mbps, to the node 1.

The transmitted ordinary packet is received by the node 1, and the input rate of the node 1 is controlled with the allowable rate of the node 1 becoming equal to the received control rate of 34 Mbps. In other words, the input rate of the node 1 is currently at 36 Mbps, the input rate is gradually reduced to the allowable rate of 34 Mbps.

As described above, when a downstream node transmits an extended packet, a node which receives the extended packet controls the input rates of the upstream nodes. That is, in the above example, the node 4 controls the input rates of the upstream nodes by way of its own input rate at the beginning. However, once the target rates of the nodes 4 and 3 are attained, the node 2 receives an extended packet. Because the target rate of the node 2 has not been attained, the node 2 controls the input rate of the node 1, which is an upstream node, by way of its own input rate.

Finally, when the input rate of the node 1 becomes 35 Mbps, as shown in FIG. 5D, the input rate of the node 2 is increased by the reduced amount of 1 Mbps. Even in this situation, there is still congestion at the node 4, and thus the nodes 4 and 3 send an extended packet whose control rate is 20 Mbps to the upstream nodes, in a similar manner to the case of FIG. 5C. When the node 2 receives the extended packet, the input rate of the node 2 is controlled with the allowable rate of the node 2 becoming equal to the rate of 35 Mbps, which is obtained by subtracting the sum of the passing traffic rate and the input rates of all the downstream nodes (=35 Mbps+10 Mbps+20 Mbps) from the ring capacity rate of 100 Mbps. In other words, because the input rate of the node 2 is currently at 35 Mbps, the input rate is kept at 35 Mbps. Furthermore, because the extended packet is received and the allowable rate 35 Mbps of the node 2 is under the target rate of 40 Mbps, the node 2 sends an ordinary packet whose control rate is the input rate of 35 Mbps, to the node 1.

The transmitted ordinary packet is received by the node 1, and the input rate of the node 1 is controlled with the allowable rate of the node 1 becoming equal to the received control rate of 35 Mbps. In other words, the input rate of the node 1 is currently at 35 Mbps, the input rate is kept at 35 Mbps. In this manner, the input rates of all the nodes 1 to 4 are stabilized, and the input rates are brought to 35 Mbps at the nodes 3 and 4 whose target rates are not attained. Thus, the bandwidths are equally distributed to the nodes 1 to 4.

As described above, according to the first embodiment, when the target rates are attained at a certain node and all the downstream nodes with respect to this node in the communication network, the node transmits an extended packet as a control frame to the upstream nodes. Thus, the input rates of the upstream nodes can be controlled by way of the input rate of the lowermost node whose target rate is not attained. This prevents the input rates of the upstream nodes from being unnecessarily reduced. As a result, oscillation of the communication rate at nodes can be avoided, and bandwidths can be equally distributed to nodes that constitute the communication network.

A second embodiment of the present invention is characterized in that the input rate of every node can be suitably controlled even when, after the input rate is stabilized at each node in a communication network, an upstream node to which data is to be transmitted is newly added.

The essential constitution and operation of each node according to the present embodiment is the same as in the first embodiment, and thus the explanation thereof is omitted. A case in which a new upstream node is added after the input rates of the nodes 1 to 4 are stabilized as in the concrete example of the first embodiment (FIG. 5D) will be explained below.

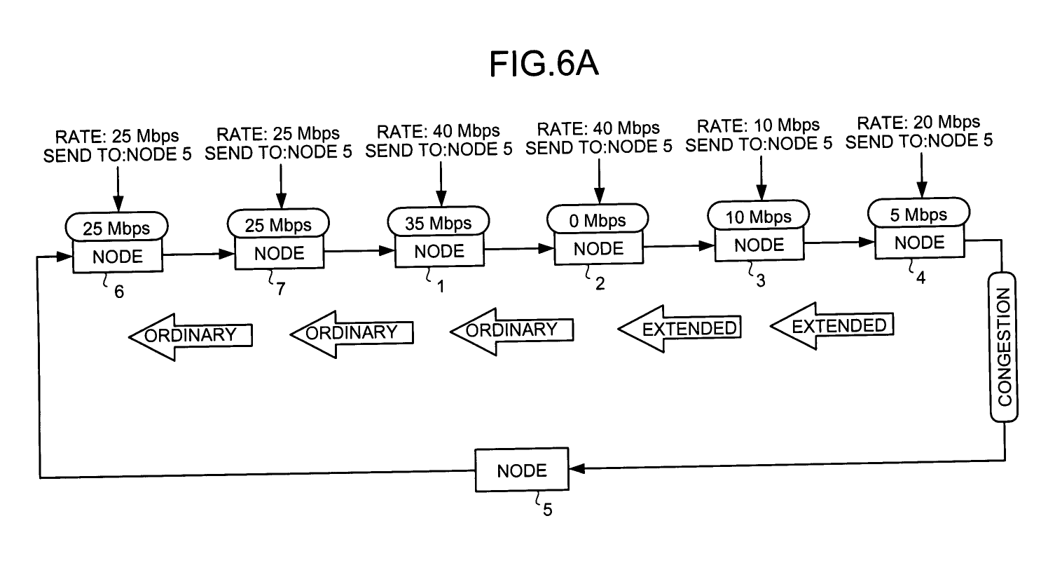

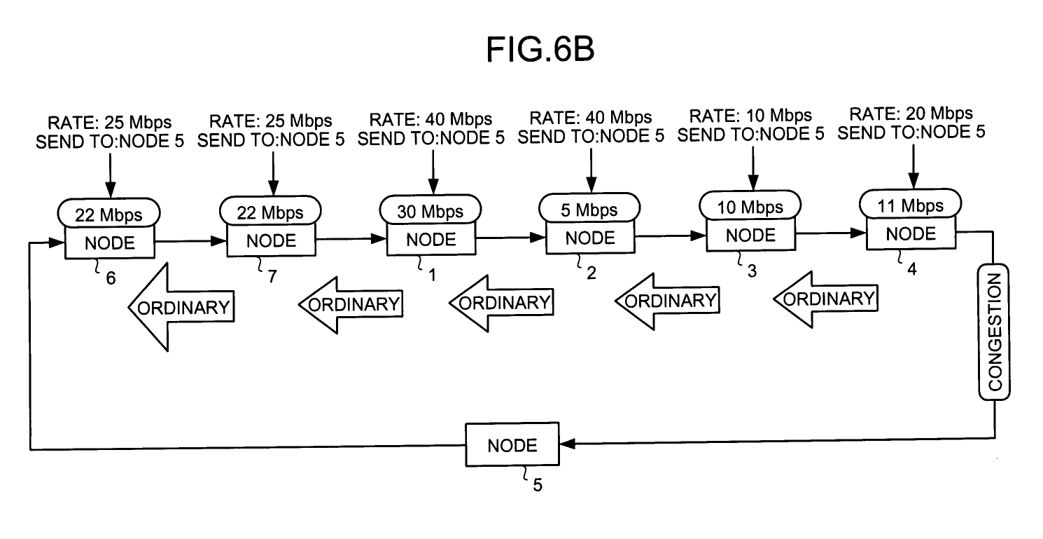

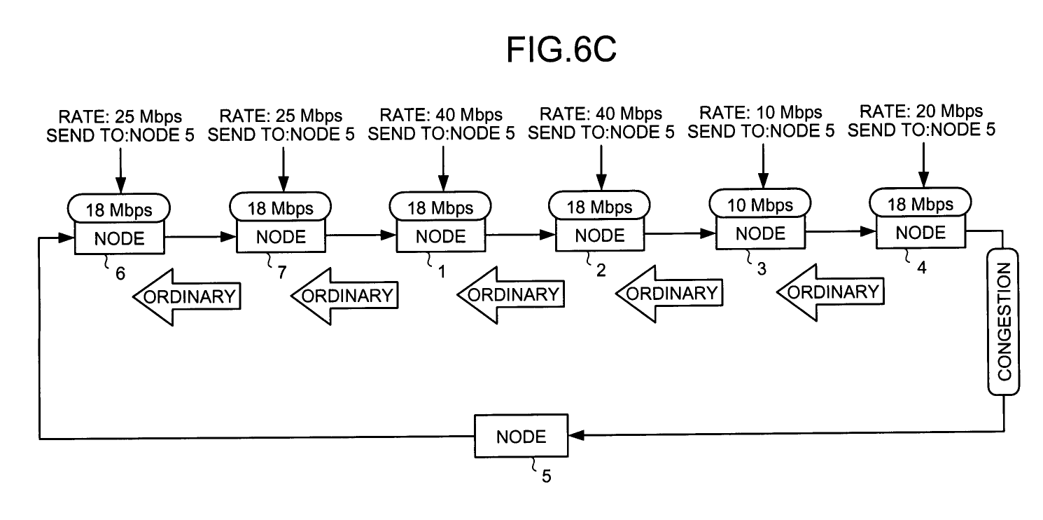

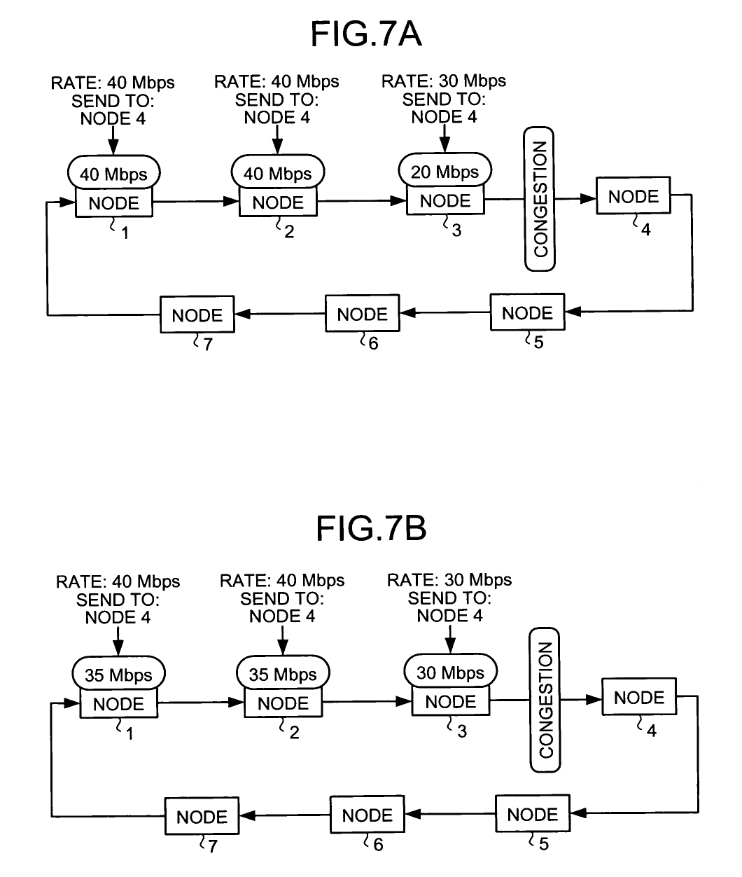

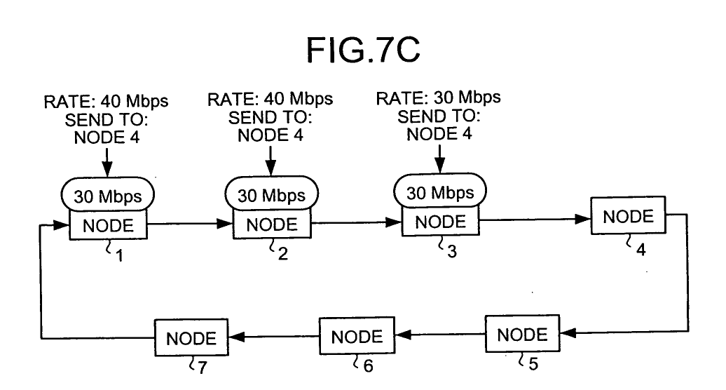

FIG. 6A is a diagram for explaining a situation in which the nodes 6 and 7 are added as the upstream nodes of the node 1 after the situation described in FIG. 5D according to the first embodiment. Each of the nodes 6 and 7 transmits data to the node 5 at the target rate of 25 Mbps. Because upstream nodes take precedence in the RPR, the newly added nodes 6 and 7 in the case of FIG. 6A have input rates that are equal to their target rates.

On the other hand, the node 2, which receives an extended packet from the node 3, has an allowable rate obtained by subtracting the sum of the passing traffic rate and the input rates of all the downstream nodes (=25 Mbps+25 Mbps+35 Mbps+10 Mbps+20 Mbps) from the ring capacity rate of 100 Mbps. However, this rate turns out to be a negative value of −15 Mbps, and thus the input rate of the node 2 is 0 Mbps. At this point, the node 2 transmits an ordinary packet to the upstream node 1, and the control rate stored in the ordinary packet is not set to the input rate of 0 Mbps, but to the received control rate of 20 Mbps. It should be noted that the received control rate is the input rate of one of the downstream nodes. If the input rate of the recipient node of the received control rate is lower than the received control rate even though it has not reached the target rate, this contradicts the precedence of upstream nodes. To resolve this contradiction, the control rate is changed to the input rate only when the input rate is greater than the received control rate. In the event of the input rate of the node 2 that is lower than the received control rate, the node 2 does not change the control rate from the received control rate.

In addition, the sum of the input rates still exceeds the ring capacity rate of 100 Mbps even with the input rate of the node 2 set to 0 Mbps. Thus, the input rate of the lowermost node 4 is reduced by 15 Mbps to 5 Mbps. The ordinary packet with the control rate of 20 Mbps is sequentially transmitted from the node 2 to the upstream nodes 1, 7 and 6, which reduces the input rates of these nodes gradually toward the control rate of 20 Mbps. As a result, for example as shown in FIG. 6B, when the input rate of the node 1 is reduced to 30 Mbps, and the input rates of the nodes 6 and 7 are reduced to 22 Mbps, the input rates of the nodes 2 and 4 increase by the reduction amount. In FIG. 6B, the input rate of the node 2 increases to 5 Mbps, and the input rate of the node 4 increases to 11 Mbps, for instance.

At the same time, because the target rate is not attained at the node 4, the control of the input rates of upstream nodes by way of the control rate is passed on from the node 2 to the node 4. In other words, the nodes 4 starts transmitting—an ordinary packet with the control rate of 11 Mbps. The ordinary packet is sequentially transmitted to the nodes 3, 2, 1, 7 and 6, and the input rates are reduced gradually to the control rate of 11 Mbps at the nodes other than the node 3 whose target rate is under the control rate and the node 2 whose input rate is under the control rate. Then, the input rates of the node 2 whose input rate is under the control rate and the lowermost node 4 whose input rate has not reached the target rate increase by the reduced amount of the input rates of the nodes 6, 7 and 1.

From then on, each node performs the same processing as in the first embodiment to bring the input rates of the nodes 6, 7, 1, 2 and 4 that have not attained the target rates, to 18 Mbps, as illustrated in FIG. 6C. The bandwidths are thereby equally distributed to all the nodes.

As discussed above, according to the second embodiment, when an upstream node is newly added after the input rates of all the nodes are stabilized, the node that controls the input rates of upstream nodes is reset to the lowermost node whose target rate is not attained. Thus, the input rates of the nodes are effectively control even after a new upstream node is added. Oscillation of the communication rate at nodes can thereby be avoided, and the bandwidths can be equally distributed to nodes that constitute the communication network.

According to an embodiment of the present invention, when the upstream node receives extended control information, this upstream node plays a key role to control the input rates of still upper nodes so that the input rate of any node would not be overly reduced. As a result, the communication rate of the nodes can be prevented from oscillating, and the bandwidths can be evenly distributed and all the downstream nodes, and controls the input rates in accordance with the control rate. Thus, the bandwidths are evenly distributed to all the nodes.

Moreover, according to an embodiment of the present invention, when the target rate is not attained at a downstream node, an upstream node determines that the control rate is the input rate of this downstream node, and the input rates are controlled in accordance with this control rate. Thus, the bandwidths are evenly distributed to all the nodes.

Furthermore, according to an embodiment of the present invention, the allowable rate is determined in consideration of the input rates of the upstream nodes and the downstream nodes except for the node of interest. The input rates of the upstream nodes are thereby suitably controlled so that the input rates of the upstream nodes, the allowable rate of the node of interest, and the input rates of the downstream nodes become equitable.

Moreover, according to an embodiment of the present invention, it enables the input rate of the node of interest to be controlled in accordance with the input rate of the downstream node whose target rate is not attained. Thus, the bandwidths re evenly distributed to all the nodes.

Furthermore, according to an embodiment of the present invention, the upstream node that receives the extended control information accurately figures out the input rate of the downstream node, based on the control rate and the difference information.

Moreover, according to an embodiment of the present invention, the allowable rate can be accurately determined when the extended control information is received.

Furthermore, according to an embodiment of the present invention, the upstream nodes that receive the extended control information accurately figures out the input rate of the downstream node, based on the control rate and the difference information, even when the control rate stored in the extended control information is changed.

Moreover, according to an embodiment of the present invention, when the passing traffic is small and the input rates of the upstream nodes do not need to be controlled, the upstream nodes are informed that there is no congestion to be considered.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication control apparatus in a node that transmits control information including a control rate for controlling an input rate of an upstream node when a congestion occurs during a data transmission from the upstream node to a downstream node in a communication network including a plurality of nodes connected in a form of a ring, the communication control apparatus comprising:
a determining unit that determines an allowable rate of data input permitted at a local node;
a generating unit that generates, when the allowable rate determined by the determining unit is equal to or greater than a target rate of the local node, extended control information including satisfaction information indicating that the target rate is achieved; and
a transmitting unit that transmits the extended control information generated by the generating unit to the upstream node.

2. The communication control apparatus according to claim 1, wherein
the determining unit determines a maximum input rate obtained by subtracting a traffic rate of data passing the local node from a transmission capacity rate of the entire communication network as the allowable rate of the local node.

3. The communication control apparatus according to claim 1, further comprising:
a control unit that includes a queue capable of storing input data of the local node, and controls an input rate of the input data that passes through the queue based on the allowable rate determined by the determining unit, wherein
the generating unit generates the extended control information when the input data is not stored in the queue.

4. The communication control apparatus according to claim 1, further comprising:
a receiving unit that receives either one of extended control information and control information in which an input rate of an arbitrary downstream node is included as the control rate, wherein
the generating unit determines whether to generate the extended control information based on a type of information received by the receiving unit.

5. The communication control apparatus according to claim 4, wherein
the generating unit generates the extended control information when the type of information received by the receiving unit is the extended control information and the allowable rate is equal to or greater than the target rate.

6. The communication control apparatus according to claim 5, wherein
the generating unit stores either one of a control rate stored in the extended control information received by the receiving unit and an input rate of the local node, whichever is greater, in the extended control information as the control rate.

7. The communication control apparatus according to claim 4, wherein
the generating unit generates the control information when the type of information received by the receiving unit is the extended control information and the allowable rate is less than the target rate.

8. The communication control apparatus according to claim 7, wherein
the generating unit stores either one of a control rate stored in the extended control information received by the receiving unit and an input rate of the local node, whichever is greater, in the control information as the control rate.

9. The communication control apparatus according to claim 4, wherein
the generating unit generates, when the receiving unit receives the control information, the control information including the control rate stored in the received control information, regardless of a magnitude relation of the allowable rate and the target rate.

10. The communication control apparatus according to claim 4, wherein
the determining unit determines, when the receiving unit receives the extended control information and the control rate stored in the extended control information is less than the input rate of the local node, a rate obtained by subtracting a sum of a traffic rate of data passing the local node and input rates of all of the downstream nodes from a transmission capacity rate of the entire communication network as the allowable rate of the local node.

11. The communication control apparatus according to claim 4, wherein
the determining unit determines, when the receiving unit receives the control information, the control rate stored in the control information as the allowable rate of the local node.

12. The communication control apparatus according to claim 4, wherein
the generating unit stores, in the extended control information, difference information relating to a difference between the control rate stored in the extended control information received by the receiving unit and the input rate of the local node.

13. The communication control apparatus according to claim 12, wherein
the determining unit calculates a sum of input rates of all of the downstream nodes by use of the difference information, and uses the calculated sum in determining the allowable rate.

14. The communication control apparatus according to claim 12, wherein
when the input rate of the local node is stored in the extended control information as the control rate, the generating unit calculates a difference between the input rate of the downstream node and the input rate of the local node as a reference, and updates the difference information with the calculated difference.

15. The communication control apparatus according to claim 4, wherein
when the control rate included in either one of the control information the extended control information received by the receiving unit is equal to or greater than a traffic rate of data passing the local node, the generating unit generates the control information without the control rate.

16. A communication control method for a communication control apparatus in a node that transmits control information including a control rate for controlling an input rate of an upstream node when a congestion occurs during a data transmission from the upstream node to a downstream node in a communication network including a plurality of nodes connected in a form of a ring, the communication control method comprising:
determining an allowable rate of data input permitted at a local node;
generating, when the allowable rate determined at the determining is equal to or greater than a target rate of the local node, extended control information including satisfaction information indicating that the target rate is achieved; and
transmitting the extended control information generated at the generating to the upstream node.
